(19) United States
(12) Patent Application Publication
(10) Pub. No.: US 2021/0107509 A1
(43) Pub. Date: Apr. 15, 2021

(54) VEHICLE CONTROL SYSTEM, VEHICLE CONTROL DEVICE, AND VEHICLE CONTROL METHOD

(71) Applicant: HONDA MOTOR CO., LTD., Minato-ku, Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/970,408

(22) PCT Filed: Oct. 5, 2018
(86) PCT No.: PCT/JP2018/037404

§ 371 Date: Aug. 17, 2020

(30) Foreign Application Priority Data
Feb. 22, 2018 (JP) 2018-029732

(51) Int. Cl. B60W 60/00; G05B 13/02; B60W 50/14; G01C 21/34

(52) U.S. Cl. CPC B60W 60/001; G01C 21/3461; B60W 50/14; G05B 13/027

(57) ABSTRACT

A vehicle control system includes a service management device configured to manage a predetermined service provided in a state in which a user is not using an automated driving vehicle in an out-of-use period which is set in a usage schedule of the automated driving vehicle by the user, and a controller configured to generate an action plan of the automated driving vehicle in the out-of-use period according to the predetermined service managed by the service management device.

### TECHNICAL FIELD

The present invention relates to a vehicle control system, a vehicle control device, and a vehicle control method.

Priority is claimed on Japanese Patent Application No. 2018-29732, filed Feb. 22, 2018, the content of which is incorporated herein by reference.

### BACKGROUND ART

In recent years, research on automated controlling of a vehicle has been underway. For example, a system configured to identify a place where a user will next use an automated driven vehicle on the basis of schedule information input by the user and set the identified place as a destination of the automated driven vehicle is known (for example, see Patent Literature 1).

### CITATION LIST

### Patent Literature

### [Patent Literature 1]

Japanese Unexamined Patent Application, First Publication No. 2012-048563

### SUMMARY OF INVENTION

### Technical Problem

However, in this conventional system, when a user does not use an automated driving vehicle after arrival at a destination, since it is necessary to park the automated driving vehicle in a parking lot to prepare for the next use of the user, in some cases, the automated driving vehicle is not able to be used sufficiently.

In consideration of the above-mentioned circumstances, the present invention is directed to providing a vehicle control system, a vehicle control device, and a vehicle control method that are capable of promoting usage of an automated driving vehicle during a period in which a user does not use the automated driving vehicle.

### Solution to Problem

A vehicle control system, a vehicle control device, and a vehicle control method according to the present invention employ the following configurations.

(1) An aspect of the present invention is a vehicle control system including: a service management device configured to manage a predetermined service provided in a state in which a user is not using an automated driving vehicle during an out-of-use period which is set in a usage schedule of the automated driving vehicle of the user; and a controller configured to generate an action plan of the automated driving vehicle in the out-of-use period according to the predetermined service managed by the service management device.

(2) In the aspect of the above-mentioned (1), the service management device notifies the user of one or more service candidates providable in the state in which the user is not using the automated driving vehicle, and performs processing such that a service selected by the user is provided as the predetermined service.

(3) In the aspect of the above-mentioned (2), the service management device notifies the user of an attribute of the service together with one or more service candidates providable in the state in which the user is not using the automated driving vehicle, the attribute of the service including at least one of (i) a content of each service included in the service candidates, (ii) a required time for each service included in the service candidates, and (iii) a permissibility for change which indicates easiness for changing each service included in the service candidates to a different service.

(4) In the aspect of the above-mentioned (1), while the predetermined service is being provided, the service management device changes the content of the predetermined service which is currently being provided at least in one of a case in which (i) a setting of the predetermined service being provided has been changed and in which (ii) it is predicted that a setting of the predetermined service being provided will be changed.

(5) In the aspect of the above-mentioned (1), the service management device changes a setting related to the predetermined service being provided on the basis of information received from a terminal device of the user while the predetermined service being provided.

(6) In the aspect of the above-mentioned (1), the service management device transmits continuation confirming notification for confirming whether provision of the service should be continued to the terminal device of the user when it is predicted that the automated driving vehicle is unable to return to a designated place by a designated time while the predetermined service being provided.

(7) In the aspect of the above-mentioned (1), the service management device determines the predetermined service on the basis of a joining time when the user joins with the automated driving vehicle after alighting of the user, the joining time being time information included in the usage schedule.

(8) An aspect of the present invention is a vehicle control device including: an acquisition part configured to acquire information related to a predetermined service provided in a state in which a user is not using the automated driving vehicle during an out-of-use period which is set in a usage schedule of the automated driving vehicle by the user; and a controller configured to generate an action plan of the automated driving vehicle in the out-of-use period on the basis of the information acquired by the acquisition part.

(9) An aspect of the present invention is a vehicle control method executed by one or more computers, the method including: managing a predetermined service provided in a state in which a user is not using an automated driving vehicle during an out-of-use period which is set in a usage schedule of the automated driving vehicle by the user; and generating an action plan of the automated driving vehicle in the out-of-use period according to the predetermined service.

### Advantageous Effects of Invention

According to the above-mentioned (1) to (9), it is possible to promote usage of an automated driving vehicle during a period in which a user does not use the automated driving vehicle.

### BRIEF DESCRIPTION OF DRAWINGS

FIG. 1 is a configuration view of a vehicle control system 1 according to an embodiment.

FIG. 2 is a configuration view of a service management device 500.

FIG. 3 is a view showing an example of details of schedule information 531.

FIG. 4 is a view showing an example of details of service conditions information 532.

FIG. 5 is a view showing an example of contents of location information 533.

FIG. 6 is a view showing an example of contents of vehicle status information 534.

FIG. 7 is a view showing an example of contents of usage history information 535.

FIG. 8 is a configuration view of a vehicle control device 5 according to an embodiment.

FIG. 9 is a functional configuration view of a first controller 120 and a second controller 160.

FIG. 10 is a sequence diagram showing an example of a flow of a series of processing by the vehicle control system 1 of the embodiment.

FIG. 11 is a flowchart showing an example of a flow of service determination processing.

FIG. 12 is a flowchart showing an example of a flow of previous confirmation processing.

FIG. 13 is a flowchart showing an example of a flow of termination instruction processing.

FIG. 14 is a flowchart showing an example of a flow of service adjustment processing.

FIG. 15 is a view showing an example of a hardware configuration of an automated driving control device 100 of an embodiment.

### DESCRIPTION OF EMBODIMENTS

Hereinafter, embodiments of a vehicle control system, a vehicle control device, and a vehicle control method of the present invention will be described with reference to the accompanying drawings.

### [Entire Configuration]

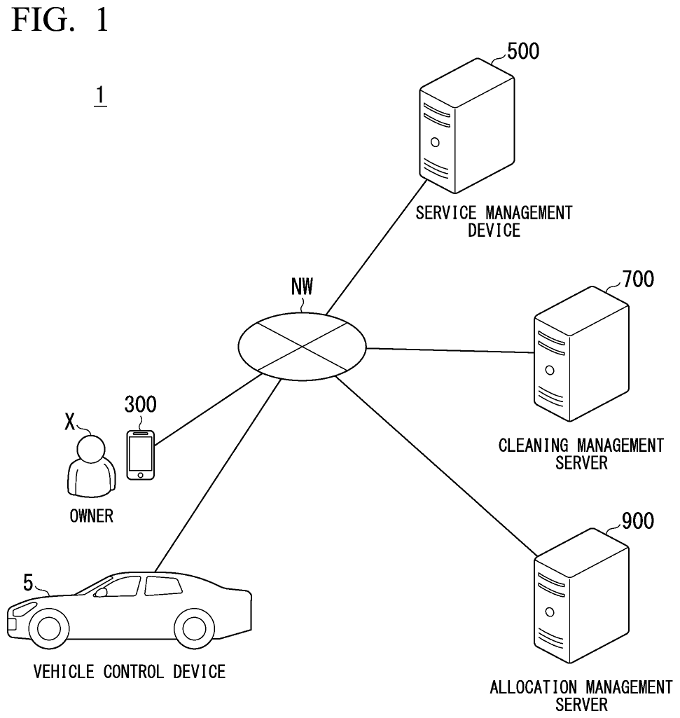

FIG. 1 is a configuration view of a vehicle control system 1 according to an embodiment. The vehicle control system 1 is realized by one or more processors (computers). The vehicle control system 1 includes, for example, one or more vehicle control devices 5, one or more terminal devices 300, a service management device 500, a cleaning management server 700 and an allocation management server 900. The vehicle control device 5 is vehicle onboard devices mounted on an automated driving vehicle having an automated driving function. The automated driving vehicle is, for example, a private vehicle of an owner X. The terminal device 300 is a terminal device owned by the owner X, and a portable terminal device having at least a communication function and an information input/out function, for example, a cellular phone such as a smart phone, a tablet terminal, a laptop computer, a personal digital assistant (PDA), or the like.

The service management device 500 manages a service provided in a state in which the owner X does not use an automated driving vehicle (hereinafter, referred to as a second service). In the second service, the automated driving vehicle is moved to a place according to the second service or travels along a path according to the second service. The second service includes, for example, a cleaning service, a car sharing service, a taxi service, a charging service, a delivery service, a delivery locker service, and the like. For example, the cleaning service is a service of causing the automated driving vehicle of the owner X to travel to a cleaning facility, and causing the automated driving vehicle to travel a designated place after completion of a cleaning work or the like in the cleaning facility (cleaning of a vehicle body, cleaning of the inside of the vehicle, change of disposition of seat sheets, checking, other maintenances, and the like). For example, the car sharing service is a service in which the automated driving vehicle of the owner X is utilized as a vehicle used by other users than the owner X (hereinafter, referred to as a shared car). For example, the taxi service is a service in which the automated driving vehicle of the owner X is utilized as a taxi. For example, the charging service is a service of causing the automated driving vehicle of the owner X to travel to a charging facility or a gas station to charge a battery of an electric vehicle, and causing the automated driving vehicle to travel to a designated place after charging by a charging facility or a gas station, or reception of supply of gasoline. The delivery service is a service in which delivery goods are placed on the automated driving vehicle and transported to a delivery destination in cooperation with a delivery company. The delivery locker service is a service in which the automated driving vehicle is utilized as a delivery locker, and for example, a service in which the automated driving vehicle takes delivery goods to a user who arrives within a predetermined time to a cargo collection center of a delivery company and stores them in the automated driving vehicle as they are, and a user who is the delivery destination of the delivery goods comes to the automated driving vehicle and delivers them.

The service management device 500 comes in communication with the cleaning management server 700 and acquires predetermined information when processing of providing a cleaning service is performed. In addition, the service management device 500 comes in communication with the allocation management server 900 and acquires predetermined information when processing of providing a car sharing service or a taxi service is performed. The service management device 500 may come in communication with other external servers and acquire information required to provide the second service (for example, information related to a usage status of a charging facility or equipment of a gas station, or the like).

The cleaning management server 700 is a server operated by a business operator such as a cleaning company or the like, and receives information related to a cleaning request from a guest and provides various services related to cleaning of the vehicle. The cleaning management server 700 selects a cleaning facility according to a cleaning request from a plurality of cleaning facilities when presentation of the cleaning facilities is instructed by the service management device 500, and transmits information related to the selected cleaning facility to the service management device 500. Services that can be provided by the cleaning facilities often differ depending on equipment and personnel of the facilities.

The allocation management server 900 is a server operated by a business operator such as a taxi company, a car sharing company, or the like, and receives information related to an allocation request or the like from a guest and provides various services related to the allocation. The allocation management server 900 instructs the allocation of the automated driving vehicle according to the allocation request from the guest to the service management device 500. For example, the allocation management server 900 transmits the information related to the allocation request from the guest (for example, a call place, a waiting time, a reservation number of people, a destination, or the like) to the service management device 500, and instructs the allocation. The call place is a place where a shared car or a taxi picks up a guest. In addition, the allocation management server 900 may transmit information indicating an area that is likely to pick up a guest when traveling as a cruising taxi without customer on board or an area where shared cars or taxis are not enough to the service management device 500.

The vehicle control device 5, the terminal device 300, the service management device 500, the cleaning management server 700 and the allocation management server 900 are connected to each other by a network NW, and come in communication with each other via the network NW. The network NW includes, for example, some or all of a wide area network (WAN), a local area network (LAN), the Internet, a dedicated line, a radio base station, a provider, and the like.

Here, an example of a usage scene of the vehicle control system 1 according to the embodiment will be described. For example, it is assumed that the owner X leaves the home by boarding in the automated driving vehicle and arrives at a shopping mall that is a destination in the morning. The owner X has a schedule that stays in the shopping mall until evening. In such a scene, the owner X can receive the second service during the period from arrival to the shopping mall to the return. For example, the owner X sets a usage time and a return point which is a designated place as schedule information of the owner X by using the terminal device 300 or an interface of the vehicle control device 5. For example, the usage time is 10 a.m. to 5 p.m., and the return point is a shopping mall. The vehicle control device 5 and the service management device 500 cause the automated driving vehicle to travel so that the vehicle can return to the shopping mall by 5 p.m. Further, the usage scene of the second service is not limited thereto, and it can be used as a taxi during the out-of-use period when the automated driving vehicle is not used by the owner X, for example, during the day of weekdays or at night on Saturdays and Sundays. In this case, the return point is the home or the like of the owner X.

### [Service Management Device 500]

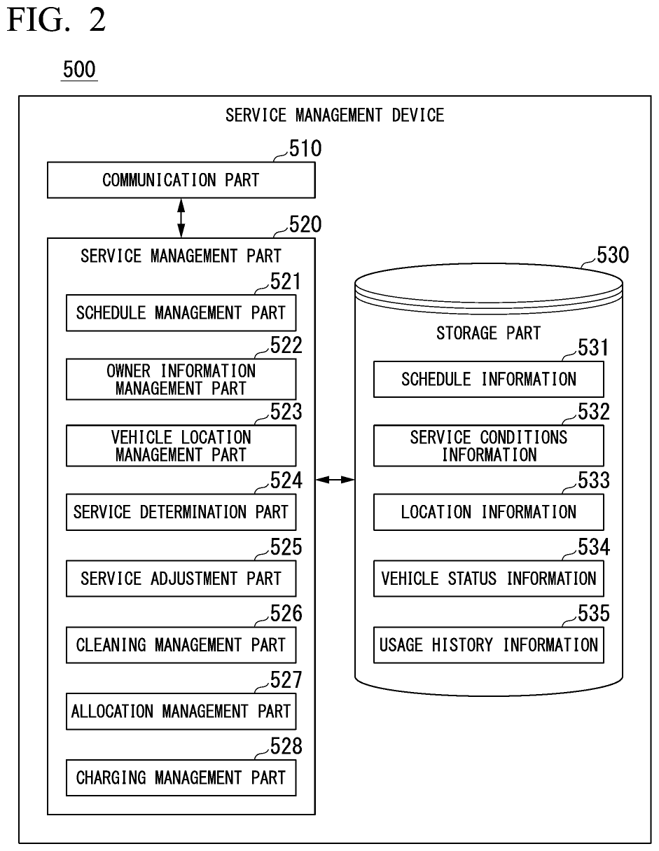

First, the service management device 500 will be described. FIG. 2 is a configuration view of the service management device 500. The service management device 500 includes a communication part 510, a service management part 520 and a storage part 530. The communication part 510 includes a communication interface such as an NIC or the like. The storage part 530 is a flash memory such as a random access memory (RAM), a read only memory (ROM), a solid state drive (SSD), or the like, a hard disk drive (HDD), or the like. The storage part 530 stores information, for example, schedule information 531, service conditions information 532, location information 533, vehicle status information 534, usage history information 535, and the like. The storage part 530 may be an external storage device such as a network attached storage (NAS) to which the service management device 500 is accessible via a network. The service management part 520 executes various types of processing described below using the information stored in the storage part 530.

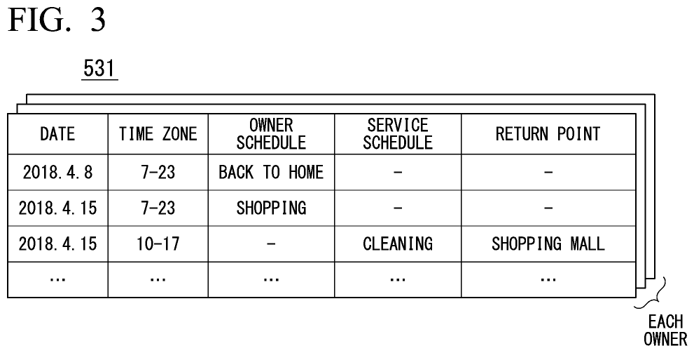

The schedule information 531 is information related to the usage schedule of the automated driving vehicle. FIG. 3 is a view showing an example of details of the schedule information 531. As shown in FIG. 3, the schedule information 531 is information in which a time zone, an owner schedule, a service schedule, and a return point are associated with dates. A table shown in FIG. 3 is prepared for each owner. The date and the time zone are a date and a time to which a usage schedule of the automated driving vehicle is set. The owner schedule is an individual schedule of the owner X, which is registered by the owner X. The owner schedule includes information indicates the usage schedule of the automated driving vehicle of the owner X, and for example, includes a destination, an intended purpose, or the like. The service schedule includes information indicating the usage schedule of the second service, and for example, includes information indicating a type of the second service. Further, in the service schedule, “∘” indicating that some kind of a second service schedule is set or “-” indicating that no second service schedule is set may be entered. The usage schedule may be set by the owner X, or may be set by the service management device 500 on the basis of the usage schedule set by the owner X, the service conditions information 532, or the like. The return point is a point to which the automated driving vehicle returns after the second service is terminated, and for example, is a point at which the owner X desires to join the automated driving vehicle.

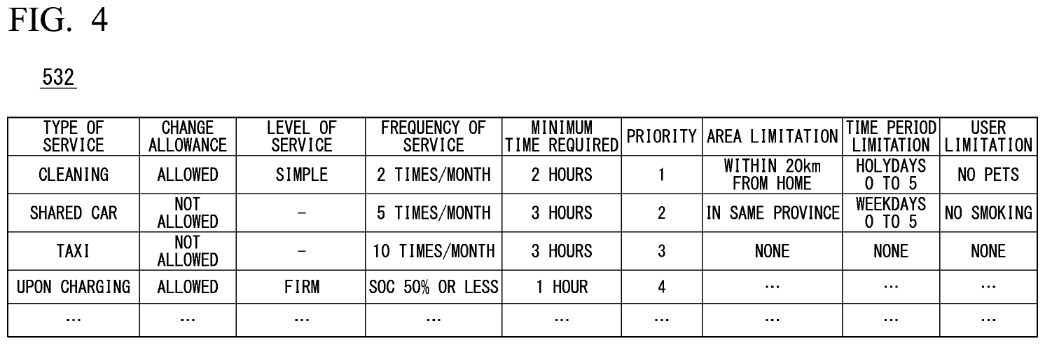

The service conditions information 532 is information indicating a service condition set by the owner X. FIG. 4 is a view showing an example of details of the service conditions information 532. As shown in FIG. 4, the service conditions information 532 is information in which permissibility for change, a degree of a service, a frequency of a service, a minimum time required, a priority, an area limitation, a time period limitation, a user limitation, and the like, are associated with types of services. The service conditions information 532 is information indicating conditions desired by the owner X when the second service is received. The type of service is information indicating a type of second service, and for example, a name of the second service. The permissibility for change is information indicating a degree to which changing the second service to a different service is permitted, and it may be defined which degree is permitted for changing the second service to a different service in addition to defining whether the change of the second service to a different service is permitted or not. The degree of the service, for example, includes a level of the provided service such as fully, briefly and the like, and with respect to the second service in which the degree of the service is set in stages, it represents such degree (level) of the provided service. The frequency of the service is a usage frequency of each second service desired by the owner X. The minimum time required is a lower limit of a time length of each second service desired by the owner X. For example, it is possible to distinguish between an owner who desires to make the automated driving vehicle travel as a taxi even if there is only 30 minutes and an owner who does not desire to make the automated driving vehicle travel as a taxi if it is not at least about two hours. The priority is a priority given when the second service provided by the service management device 500 is determined. The area limitation indicates an area in which the automated driving vehicle can travel during provision of the second service. The time period limitation indicates a time zone in which the automated driving vehicle can travel during provision of the second service. The user limitation indicates a limit of a guest who is allowed to ride in the automated driving vehicle.

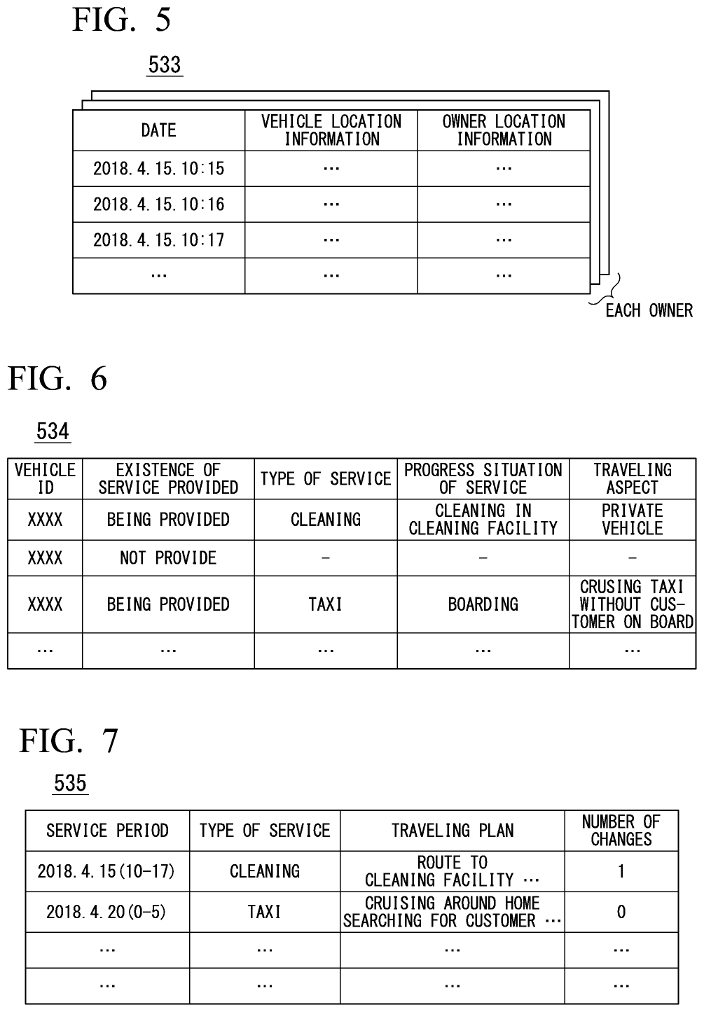

The location information 533 is information designating a position of the automated driving vehicle. FIG. 5 is a view showing an example of details of the location information 533. As shown in FIG. 5, the location information 533 is information in which the vehicle location information and the owner location information are associated with the date and the time. The vehicle location information is information indicating a position of the automated driving vehicle acquired by a navigation device 50. The owner location information is information indicating a location of the terminal device 300 acquired by a global navigation satellite system (GNSS) or the like of the terminal device 300 owned by the owner X.

The vehicle status information 534 is information indicating a state of each automated driving vehicle. FIG. 6 is a view showing an example of details of the vehicle status information 534. As shown in FIG. 6, the vehicle status information 534 is information in which existence of service provision, a type of service, a progress state of the service, a traveling aspect, a return point, a traveling aspect, and the like, are associated with a vehicle ID. The vehicle ID is identification information that identifies each automated driving vehicle. The existence of service provision is information indicating whether the service is being provided. The progress state of the service is information indicating a progress level of the service being provided, details of the service being provided, or the like. The traveling aspect is a traveling aspect of the automated driving vehicle, which includes, for example, a cruising taxi without customer on board, a call taxi, a private vehicle, or the like. The traveling aspect will be described below in detail.

The usage history information 535 is history information of the second service provided to each owner X. FIG. 7 is a view showing an example of details of the usage history information 535. As shown in FIG. 7, the usage history information 535 is information in which a type of service, a first action plan, the number of changes, and the like, are associated with a service period. The service period and the first action plan will be described below. The number of changes is the number of times that contents of the service to be provided are changed.

Returning to FIG. 2, the service management part 520 includes, for example, the schedule management part 521, an owner information management part 522, a vehicle location management part 523, a service determination part 524, a service adjustment part 525, a cleaning management part 526, an allocation management part 527, and a charging management part 528. Some or all of these components are realized by a processor such as a central processing unit (CPU) executing a program (software) stored in the storage part 530. In addition, some or all of the functions of these components may be realized by hardware (a circuit part; including a circuitry) such as large scale integration (LSI), an application specific integrated circuit (ASIC), a field-programmable gate array (FPGA), a graphics processing unit (GPU), and the like, or may be realized by cooperation of software and hardware.

The schedule management part 521 updates the schedule information 531 on the basis of the information received from the vehicle control device 5 or the terminal device 300 using the communication part 510. In addition, the schedule management part 521 may create a usage schedule of the automated driving vehicle with reference to the schedule information 531 and the service conditions information 532, and may add the created usage schedule to the schedule information 531. For example, the schedule management part 521 creates a service schedule in a set time zone (for example, a period from 0 a.m. to 5 p.m. of a weekday) on the basis of a time period limitation of the service conditions information 532.

The owner information management part 522 updates the service conditions information 532 on the basis of the information received from the terminal device 300 using the communication part 510.

The vehicle location management part 523 updates the location information 533 on the basis of the location information received from the vehicle control device 5 using the communication part 510. In addition, the vehicle location management part 523 may also update the location information 533 on the basis of the location information received from the terminal device 300 using the communication part 510.

The service determination part 524 determines the period (hereinafter, the service period) in which the second service can be provided by the service management device 500. For example, the service determination part 524 refers to the schedule information 531, and determines the out-of-use period in which the owner X does not use the automated driving vehicle among the usage schedule of the automated driving vehicle (for example, the period in which the schedule of the owner X is not planned, and the period in which some schedule for the second service is set by the owner X) as the service period. The service period includes, for example, nighttime or daytime on weekdays when the owner X does not use the automated driving vehicle, or a period in which the owner X does not use the automated driving vehicle while visiting somewhere outside (for example, a period from arriving at the shopping mall until returning). Further, the service determination part 524 may, with reference to the service conditions information 532, determine a period that matches the service condition among the period in which the owner X does not use the automated driving vehicle as the service period.

The service determination part 524 may determine the service period on the basis of the time information included in the schedule information 531. For example, in the vehicle heading toward the shopping mall, when a joining time when it is required to join with the owner X is set by the owner X after the owner X alights, the schedule management part 521 registers a schedule as the schedule information 531 in which the current time is set as a starting time and the set joining time is set as a finish time. The service determination part 524 determines, with reference to the schedule information 531, a period from a time when the owner X alights until the set joining time as the service period.

The service determination part 524 determines the finish time of the service period as a return time of the automated driving vehicle.

The service determination part 524 determines the second service (hereinafter, referred to as a service to be provided) provided in the service period. For example, the service determination part 524 determines any one of one or more second services (hereinafter, referred to as service candidate) in which the automated driving vehicle can return to the designated return point by the finish time of the service period as the service to be provided. The service determination part 524 determines the service candidate on the basis of the usage limitation when there is a usage limitation according to each second service. For example, the cleaning service has restrictions on the number of cleaning facilities provided, the number of vehicles that can be cleaned in each cleaning facility, or the like. For this reason, the service determination part 524 acquires information related to a usage status of the cleaning facility from the cleaning management server 700, and determines a service candidate on the basis of the acquired information. In addition, in the car sharing service, there may be a limited space in which the shared car is stopped or parked. For this reason, the service determination part 524 acquires information related to the shared car and the usage status of the space in which the shared car is stopped or parked from the allocation management server 900, and determines a service candidate on the basis of the acquired information.

For example, the service determination part 524 notifies the owner of the service candidate by transmitting the information related to the service candidate to the vehicle control device 5 or the terminal device 300 using the communication part 510. The information related to the service candidates is information indicating attributes of the second service included in the service candidates, and for example, includes details of the second service included in the service candidates, a time required of the second service included in the service candidates, permissibility for change indicating easiness of change of the second service included in the service candidates, and the like. The details of the second service includes, for example, a type of the second service, a position on a map of a facility used, an area of a traveling route, a destination set when traveling as a shared car or taxi, and the like. The permissibility for change of the second service is, for example, information indicating flexibility when a service provider changes the schedule at the beginning while the second service is provided. For example, the permissibility for change is high when a usage status in the cleaning facility included in the service candidate is not congested, and the permissibility for change is low when the usage state is congested. The owner X can select the desired second service from the plurality of service candidates with reference to the attributes of the second service. The service determination part 524 determines the second service selected by the owner X from the service candidates as the service to be provided on the basis of the information received from the vehicle control device 5 or the terminal device 300 using the communication part 510.

In addition, the service determination part 524 may determine the second service that most matches the service condition from the service candidates as the service to be provided with reference to the service conditions information 532. The second service that most matches the service condition includes, for example, a second service having the lowest ratio of an actual usage frequency with respect to a frequency defined as “a frequency of service” (a usage frequency desired by the owner X), a second service having a minimum difference between a length of a time defined as “a minimum time required” and a length of a service period determined by the service determination part 524, a second service with the highest priority defined as “priority,” a second service having a largest service period included in the time zone defined as “time zone limitation,” and the like. In addition, the service determination part 524 may compositely derive a degree of agreement with the service condition on the basis of a plurality of conditions, and determine the service to be provided on the basis of the derived degree.

In addition, the service determination part 524 may determine a second service that matches a usage trend of the owner X from the service candidates as the service to be provided with reference to the usage history information 535. For example, the service determination part 524 derives a day of the week and a time zone having a high usage trend of each second service, and determines a second service in which a coinciding portion (a time length) between the derived day of the week and time zone and the service period is largest as the service to be provided.

The service determination part 524 may transmit the information related to the service to be provided to the vehicle control device 5 or the terminal device 300 using the communication part 510, obtains agreement of provision of the service to be provided during the service period from the owner X, and perform processing of providing the service to be provided when the agreement from the owner X is obtained.

In addition, when the second service in the service period is previously set by the owner X, the service determination part 524 may determine such second service as the service to be provided.

In addition, in the service determination part 524, when the strictness of the service period is set to be low, the second service may be determined as the service to be provided even if it is the second service that exceeds the service period. Further, setting of the strictness of the service period is set by the owner X as a part of the service conditions information 532.

During provision of the service, the service determination part 524 derives a time (hereinafter, referred to as a service usage finish time) when usage of the service provided will terminate in order to return to the return point by the finish time of the service period on the basis of the current time and the current location of the automated driving vehicle. For example, when the service to be provided is the cleaning service, the service usage finish time is the latest time to leave the cleaning facility. When the service to be provided is the car sharing service or the taxi service, the service usage finish time is a time when traveling as a shared car or a taxi is terminated. For example, the service determination part 524 525 calculates the service usage finish time backward from the finish time of the second service period on the basis of a total time obtained by adding a predetermined allowance time to a time when traveling from the current position of the automated driving vehicle or a destination (for example, a place of a cleaning facility or a destination set by a guest of a shared car or a taxi) to a return point. Further, the service determination part 524 may derive the second service usage finish time on the basis of traffic congestion in the route to the return point, traffic congestion in the route to the destination, or the like. Then, the service determination part 524 transmits the derived service usage finish time to the vehicle control device 5.

The service determination part 524 determines a first action plan in the service period. The first action plan includes, for example, a destination, a traveling aspect, a traveling schedule, a traveling route, and the like. In addition, the first action plan includes information that causes the automated driving vehicle to travel, information of stopping or parking the automated driving vehicle for waiting, and the like. Further, items included in the first action plan may be different according to a type of the second service. The destination is a destination at which the second service is provided, and includes, for example, a location on a map of a cleaning facility, a location on a map of a space in which the shared car is stopped or parked, a location on a map of a charging station, and the like. The traveling aspect includes an aspect of traveling as an individual vehicle, an aspect of traveling as a taxi, and the like. When traveling as the taxi, the traveling aspect includes an aspect of traveling as a taxi that allows boarding of a guest who shows a boarding intension by raising a hand in the middle of traveling (hereinafter, referred to as a cruising taxi without customer on board), an aspect of traveling as a taxi that picks up a guest at a call point specified by the guest (hereinafter, referred to as a call taxi), or the like. The traveling schedule and the traveling route are items that are mainly set in the taxi service. The traveling schedule includes a priority or time of each traveling aspect. The traveling route includes a traveling area (a center before a station, a center of a town), a priority road (give priority to driving a main street), and the like. Further, the service determination part 524 may refer to the storage part 530 and change the first action plan while the second service is provided (i.e., in the middle of the second service period).

The service adjustment part 525 adjusts provision of the second service determined by the service determination part 524. For example, before starting of the service to be provided, the service adjustment part 525 checks whether the service to be provided which is planned to be provided can be provided, or checks whether the service to be provided can be provided within the service period. When the checked result is negative (the service cannot be provided within the service period, or the like), the service adjustment part 525 instructs the service determination part 524 to determine the alternative solution. The service determination part 524 sets the determined alternative solution as the service to be provided.

In addition, the service adjustment part 525 derives a predicted time (hereinafter, a predicted arrival time) when the automated driving vehicle will arrive at the return point on the basis of traffic congestion of a road, a congestion state of the facility used for the service, or the like, while the service to be provided is provided.

In addition, the service adjustment part 525 changes contents of the service being provided when setting of the service being provided is changed while the service to be provided is being provided. Changing setting of the service being provided includes, for example, changing (including shortening or extending) the finish time of the service period, changing a degree of the service (a cleaning level is changed from “briefly” to “firm”), and the like. Changing the finish time of the service period may be changed by the owner X or may be changed by the service adjustment part 525.

For example, when termination of the service being provided by the owner X is instructed, the service adjustment part 525 terminates (or interrupts) the service being provided, and instructs the vehicle control device 5 to cause the automated driving vehicle to immediately travel toward the return point. Further, when it takes time for the automated driving vehicle to return to the return point, the service adjustment part 525 may arrange the alternative vehicle and pick up the owner X who waits for the alternative vehicle at the return point. In addition, when the automated driving vehicle is used as a shared car or a taxi with passengers, the service adjustment part 525 may arrange the other vehicle for transferring the passengers who are in the automated driving vehicle so that the automated driving vehicle can return to the return point. Details of these processings performed by the service adjustment part 525 will be described in termination instruction processing, which will be described below.

In addition, the service adjustment part 525 changes the contents of the service being provided when setting of the service being provided is predicted to be changed while the service to be provided is provided. For example, the service adjustment part 525 derives a predicted arrival time when the automated driving vehicle will arrive at the return point, and predicts that the automated driving vehicle will be late when the derived predicted arrival time exceeds the set return time. In this case, the service adjustment part 525 terminates (or interrupts) the service being provided, and instructs the vehicle control device 5 to cause the automated driving vehicle to immediately travel toward the return point. In addition, the service adjustment part 525 acquires the location information of the owner X with reference to the location information 533, derives the predicted time when the owner X will arrive at the return point, and predicts that the owner X will be late when the derived predicted time exceeds the finish time of the service period. In this case, the service adjustment part 525 may change setting (a return time or a return point) of the service being provided, and extend the service being provided. Details of these processings performed by the service adjustment part 525 will be described in the service adjustment processing, which will be described below.

In addition, the service adjustment part 525 may change the setting (the return time, the return point, or the like) of the service being provided on the basis of the predicted arrival time of the automated driving vehicle derived on the basis of traffic congestion of a road, a congestion status of a facility used in the service, or the like, and transmits the changed setting to the terminal device 300. The service adjustment part 525 continues provision of the service with the changed contents when instruction of approving the change of the service being provided is received from the terminal device 300. Accordingly, the service being provided can be completed as scheduled.

In addition, the service adjustment part 525 may determine whether to change the service or not on the basis of importance of the schedule set in the usage schedule of the automated driving vehicle. For example, when the schedule with high importance is planned after the service period, the service adjustment part 525 does not change to a content that exceeds the finish time of the service period.

In addition, the service adjustment part 525 may refer to the service conditions information 532, and determine whether to change the service on the basis of the permissibility for change that is one of the conditions. For example, the service adjustment part 525 determines to change the service when the permissibility for change is high, and determines not to change the service when the permissibility for change is low.

The cleaning management part 526 comes in communication with the allocation management server 900 using the communication part 510, transmits a request instruction of retrieval of the cleaning facility according to a request of the owner X, and receives the retrieval result. The cleaning management part 526 determines the cleaning facility that matches the service condition from the retrieval result with reference to the service conditions information 532 of the storage part 530.

The allocation management part 527 refers to the storage part 530, retrieves the automated driving vehicle that matches the allocation request received from the allocation management server 900 (or a guest), and transmits call information to the automated driving vehicle obtained by the retrieval. The automated driving vehicle that matches the allocation request is a vehicle that satisfies, for example, an allocation condition, among a plurality of automated driving vehicles, previously registered in the storage part 530. The allocation condition includes, for example, conditions that a reservation number of people is equal or smaller than the capacity, it is possible to arrive at the call place by the waiting time, and it is possible to return to the return point by the finish time of the service period after traveling as a taxi to the destination. In addition, the allocation condition may include satisfying the service condition. Satisfying the service condition includes, for example, conditions that attribute of a guest who calls a taxi satisfies a user limitation of the service condition, a destination is within a range of area limitation, and the like.

The call information includes a call place, a reservation number of people, a destination, attribute information (smoker, pet companion, or the like) of a guest, a main address of the guest, identification information assigned to the guest, a reservation number, and the like. The allocation management part 527 generates call information on the basis of an allocation request from the allocation management server 900.

The charging management part 528 comes in communication with a management server (not shown) configured to manage a charging station or the like using the communication part 510, transmits a request instruction of retrieval of the charging station or the like according to a request of the owner X, and receives the retrieval result. The charging management part 528 determines the charging station or the like that matches the service condition from the retrieval result with reference to the service conditions information 532 of the storage part 530.

### [Vehicle Control Device 5]

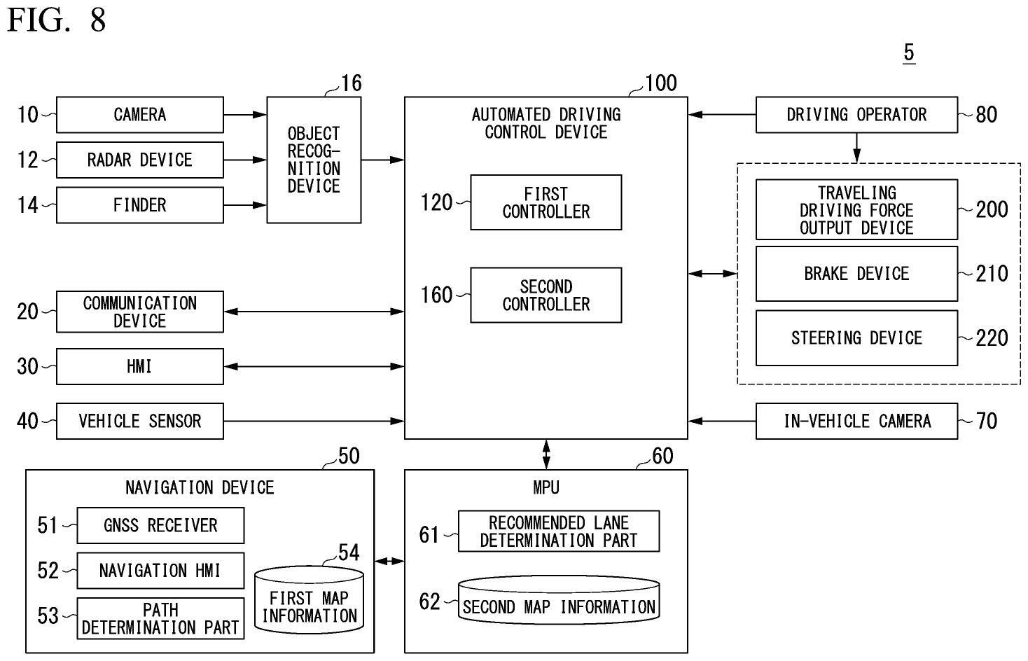

Next, the vehicle control device 5 will be described. FIG. 8 is a configuration view of the vehicle control device 5 according to the embodiment. A vehicle on which the vehicle control device 5 is mounted is, for example, a two-wheeled, three-wheeled or four-wheeled vehicle, and a driving source thereof is an internal combustion engine such as a diesel engine, a gasoline engine, or the like, an electric motor, or combination thereof. The electric motor is operated using a generated output by a generator connected to the internal combustion engine, or a discharged output of a secondary battery or a fuel cell.

The vehicle control device 5 includes, for example, a camera 10, a radar device 12, a finder 14, an object recognition device 16, a communication device 20, a human machine interface (HMI) 30, a vehicle sensor 40, the navigation device 50, a map positioning unit (MPU) 60, an in-vehicle camera 70, a driving operator 80, an automated driving control device 100, a traveling driving force output device 200, a brake device 210 and a steering device 220. These devices or instruments are connected to each other by a multiple communication line such as a controller area network (CAN) communication line or the like, a serial communication line, a wireless communication network, or the like. Further, the configuration shown in FIG. 8 is merely an example, a part of the configuration may be omitted, and another configuration may be added.

The camera 10 is, for example, a digital camera using a solid-state image sensing device such as a charge coupled device (CCD), a complementary metal oxide semiconductor (CMOS), or the like. The camera 10 is attached to an arbitrary place of the automated driving vehicle on which the vehicle control device 5 is mounted. When a side in front of the vehicle is imaged, the camera 10 is attached to an upper section of a front windshield, a rear surface of a rearview mirror, or the like. The camera 10 images, for example, a periphery of the automated driving vehicle repeatedly periodically. The camera 10 may be a stereo camera.

The radar device 12 radiates radio waves such as millimeter waves or the like to surroundings of the automated driving vehicle, and simultaneously, detects the radio waves (reflected waves) reflected by the object to detect a position (a distance and an azimuth) of at least the object. The radar device 12 is attached to an arbitrary place of the automated driving vehicle. The radar device 12 may detect a position and a velocity of the object using a frequency modulated continuous wave (FM-CW) method.

The finder 14 is light detection and ranging (LIDAR). The finder 14 radiates light to surroundings of the automated driving vehicle, and measures the scattered light. The finder 14 detects a distance to a target on the basis of a time from emission to reception of light. The radiate light is, for example, a pulse-shaped laser beam. The finder 14 is attached to an arbitrary place of the automated driving vehicle.

The object recognition device 16 recognizes a position, a type, a velocity, or the like, of the object by performing sensor fusion processing with respect to the detection result by some or all of the camera 10, the radar device 12, and the finder 14. The object recognition device 16 outputs the recognized result to the automated driving control device 100. The object recognition device 16 may output the detection results of the camera 10, the radar device 12 and the finder 14 to the automated driving control device 100 as they are. The object recognition device 16 may be omitted from the vehicle control device 5.

The communication device 20 uses, for example, a cellular network, a Wi-Fi network, a Bluetooth (registered trademark), dedicated short range communication (DSRC), or the like, comes in communication with another vehicle present in the vicinity of the automated driving vehicle, or comes in communication with various server devices via a radio base station.

The HMI 30 receives an input operation by an occupant in the automated driving vehicle while providing various types of information to the occupant. The HMI 30 includes various display devices, a speaker, a buzzer, a touch panel, a switch, a key, and the like.

The vehicle sensor 40 includes a vehicle speed sensor configured to detect a velocity of the automated driving vehicle, an acceleration sensor configured to detect an acceleration, a yaw rate sensor configured to detect an angular velocity around a vertical axis, an azimuth sensor configured to detect a direction of the automated driving vehicle, and the like.

The navigation device 50 includes, for example, a GNSS receiver 51, a navigation HMI 52 and a path determination part 53. The navigation device 50 holds first map information 54 in a storage device such as an HDD, a flash memory, or the like. The GNSS receiver 51 specifies a position of the automated driving vehicle on the basis of a signal received from the GNSS satellite. The position of the automated driving vehicle may be specified or complemented by an inertial navigation system (INS) that uses output of the vehicle sensor 40. The navigation HMI 52 includes a display device, a speaker, a touch panel, a key, and the like. The navigation HMI 52 may be partially or entirely shared with the HMI 30 described above. The path determination part 53 determines, for example, a path (hereinafter, a path on a map) from a position of the automated driving vehicle specified by the GNSS receiver 51 (alternatively, an input arbitrary position) to a destination input by an occupant using the navigation HMI 52 with reference to the first map information 54. The first map information 54 is, for example, information in which a road shape is expressed by a link showing a road and a node connected by the link. The first map information 54 may include a curvature of a road, point of interest (POI) information, or the like. The path on a map is output to the MPU 60. The navigation device 50 may perform path guidance using the navigation HMI 52 on the basis of the path on a map. The navigation device 50 may be realized by, for example, a function of a terminal device such as a smart phone, a tablet terminal, or the like, held by the occupant. The navigation device 50 may transmit the current position and the destination to the navigation server via the communication device 20, and may acquire an equivalent path as the path on a map from the navigation server.

The MPU 60 includes, for example, a recommended lane determination part 61, and holds second map information 62 in a storage device such as an HDD, a flash memory, or the like. The recommended lane determination part 61 divides the path on a map provided from the navigation device 50 into a plurality of blocks (for example, divided at each 100 [m] in an advance direction of the vehicle), and determinations a recommended lane for each block with reference to the second map information 62. The recommended lane determination part 61 performs determination such as which lane from the left the vehicle travels. The recommended lane determination part 61 determines a recommended lane so that the automated driving vehicle can travel a reasonable path to proceed to a branch destination when a diverging point is present on the path on a map.

The second map information 62 is map information that is more accurate than the first map information 54. The second map information 62 includes, for example, information of a center of a lane, information of a boundary of a lane, or the like. In addition, the second map information 62 may include road information, traffic regulation information, address information (address/zip code), facility information, telephone number information, and the like. The second map information 62 may be updated at any time by bringing the communication device 20 in communication with another device.

The in-vehicle camera 70 is, for example, a digital camera using a solid-state image sensing device such as a CCD, a CMOS, or the like. The in-vehicle camera 70 is attached to an arbitrary place to image the inside of the automated driving vehicle.

The driving operator 80 includes, for example, an acceleration pedal, a brake pedal, a shift lever, a steering wheel, a modified steer, a joystick, and other operators. A sensor configured to detect an operation amount or existence of an operation is attached to the driving operator 80, and the detection result is output to some or all of the automated driving control device 100, the traveling driving force output device 200, the brake device 210, and the steering device 220.

The automated driving control device 100 includes, for example, a first controller 120 and a second controller 160. The first controller 120 and the second controller 160 are realized by executing a program (software) using a hardware processor such as a CPU or the like. In addition, some or all of these components may be realized by hardware (a circuit part; including a circuitry) such as LSI, ASIC, FPGA, GPU, or the like, or may be realized by cooperation of software and hardware. The program may be previously stored in a storage device such as an HDD, a flash memory, or the like, of the automated driving control device 100, stored in a detachable storing medium such as a DVD, a CD-ROM, or the like, or installed on an HDD or a flash memory of the automated driving control device 100 by mounting a storing medium on a drive device.

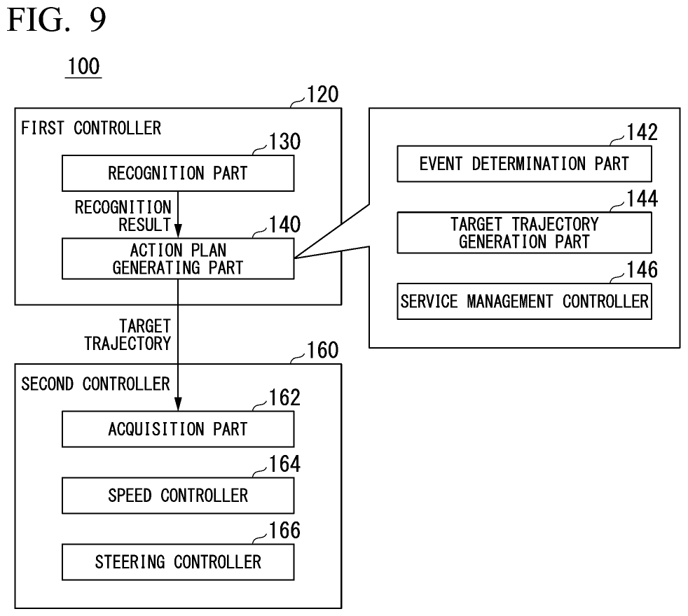

FIG. 9 is a functional configuration view of the first controller 120 and the second controller 160. The first controller 120 includes, for example, a recognition part 130 and an action plan generating part 140. The first controller 120 realizes both of a function of artificial intelligence (AI) and a function of a previously provided model in parallel. For example, regarding a function of “recognizing a crossroad”, a recognition of a crossroad through deep learning or the like and a recognition based on a predetermined condition (a signal, road markings, or the like that are able to be detected by pattern matching) may be executed in parallel, and the function of “recognizing a crossroad” may be realized by scoring and comprehensively evaluating them. Accordingly, reliability of automated driving is guaranteed.

The recognition part 130 recognizes a state such as a position, a velocity, an acceleration or the like, of an object around the automated driving vehicle on the basis of information input from the camera 10, the radar device 12, and the finder 14 via the object recognition device 16. For example, the position of the object is recognized as a position of absolute coordinates using a representative point (a center of gravity, a driving axial center, or the like) of the automated driving vehicle as an origin, and the position of the object is used for control. The position of the object may be represented by a representative point such as a center of gravity, a corner, or the like, of the object, or may be represented as a representative region. The “state” of the object may include an acceleration, a jerk, or “an action state” (for example, whether a lane change is performed or a lane change is planned to be performed) of the object.

In addition, the recognition part 130 recognizes, for example, a lane in which the automated driving vehicle is traveling (a traveling lane). For example, the recognition part 130 recognizes a traveling lane by comparing a pattern (for example, arrangement of solid lines and broken lines) of road marking lines obtained from the second map information 62 with a pattern of road mark lines around the automated driving vehicle recognized from an image captured by the camera 10. Further, the recognition part 130 may recognize a traveling lane by recognizing traveling lane boundaries (road boundaries) including road mark lines, road shoulders, curbstones, median strips, guardrails, and the like, while not being limited to road marking lines. In such recognition, a position of the automated driving vehicle acquired by the navigation device 50 or a processing result by the INS may be added. In addition, the recognition part 130 recognizes a temporary stop line, an obstacle, a red signal, a tollgate, and other road events.

The recognition part 130 recognizes a position or an attitude of the automated driving vehicle with respect to the traveling lane when the traveling lane is recognized. The recognition part 130 may recognize, for example, a separation from a lane center of a reference point of the automated driving vehicle and an angle with respect to a line that connects a center of the lane of the automated driving vehicle in an advance direction as a relative position and an attitude of the automated driving vehicle with respect to the traveling lane. Instead of this, the recognition part 130 may recognize a position or the like of a reference point of the automated driving vehicle with respect to any side end portion (a road mark line or a road boundary) of the traveling lane as a relative position of the automated driving vehicle with respect to the traveling lane.

The action plan generating part 140 may generate, for example, a second action plan of the automated driving vehicle in the service period according to the service managed by the service management device 500. The second action plan includes information of causing the automated driving vehicle to travel, information of stopping or parking the automated driving vehicle for waiting, and the like. Further, the first action plan is a rough action plan determined to execute the service, and the second action plan is a detailed action plan to travel or stop the automated driving vehicle. The second action plan includes an automated driving event determined by an event determination part 142, a target trajectory generated by a target trajectory generating part 144, or the like.

The action plan generating part 140 includes, for example, the event determination part 142, the target trajectory generating part 144 and a service management controller 146. The event determination part 142 determines an automated driving event in a path in which the recommended lane is determined. The event is information that prescribes a traveling aspect of the automated driving vehicle. The automated driving event is a fixed speed traveling event, a low speed following traveling event, a lane change event, a diverging event, a merging event, a take-over event, or the like. In addition, the event determination part 142 may change the previously determined event to another event or determine a new event according to a surrounding situation recognized by the recognition part 130 when the automated driving vehicle is traveling.

The target trajectory generating part 144 generates a future target trajectory that causes the automated driving vehicle to travel automatically (independent of a driver's operation) with an traveling aspect prescribed by the event so that the automated driving vehicle travels the recommended lane determined by the recommended lane determination part 61 in principle, and further, so that the automated driving vehicle can correspond to a surrounding situation when the automated driving vehicle travels the recommended lane. The target trajectory includes, for example, a position element that determines a future position of the automated driving vehicle, and a velocity element that determines a future velocity or the like of the automated driving vehicle. For example, the target trajectory generating part 144 generates a target trajectory according to an event started by the event determination part 142.

For example, the target trajectory generating part 144 determines a plurality of points (trajectory points) at which the automated driving vehicle should arrive in sequence as a position element of the target trajectory. The trajectory point is a point at which the automated driving vehicle should arrive at each of predetermined traveling distances (for example, about every several [m]). The predetermined traveling distance may be calculated, for example, by a road distance traveled along the path.

In addition, the target trajectory generating part 144 determines a target velocity and a target acceleration of each predetermined sampling time (for example, about every several fractions of a [sec]) as a velocity element of the target trajectory. In addition, the trajectory point may be a position at which the automated driving vehicle should arrive at a specific sampling time among predetermined sampling times. In this case, the target velocity or the target acceleration is determined by interval between the sampling times and the trajectory points. The target trajectory generating part 144 outputs the information indicating the generated target trajectory to the second controller 160.

The service management controller 146 causes the automated driving vehicle to travel in the service period determined by the service management device 500, and causes the automated driving vehicle to travel so as to return to the return point by the finish time of the service period. For example, the service management controller 146 causes the automated driving vehicle to travel towards a cleaning facility, a call place of a taxi, a charging station, or the like, according to an instruction by the service management device 500 (alternatively, according to the first action plan created by the service management device 500). Here, for example, the service management controller 146 instructs the navigation device 50 to determine a path until the destination on the basis of the first action plan received from the service management device 500. Accordingly, the MPU 60 determines a recommended lane, the event determination part 142 determines an event, or the target trajectory generating part 144 generates a target trajectory. Since the second controller 160 controls the devices on the basis of the information output from the first controller 120 through such processing, the automated driving vehicle can travel according to the first action plan.

In addition, the service management controller 146 monitors whether the service usage finish time is reached on the basis of the service usage finish time received from the service management device 500. When the service usage finish time is reached (exactly that time or when that time has passed, the same applied hereinafter), the service management controller 146 terminates or interrupts the service and causes the automated driving vehicle to travel toward the return point.

In this way, the action plan generating part 140 can generate a second action plan that causes the automated driving vehicle to travel or stop according to the first action plan instructed by the service management device 500. For example, the service management controller 146 causes the automated driving vehicle to travel along an optimal path to the cleaning facility, and causes the automated driving vehicle to travel along an optimal path to the return point when the cleaning in the cleaning facility is terminated. In addition, the service management controller 146 may cause the automated driving vehicle to travel as a cruising taxi having no customer on board until there is a call from a guest, and cause the automated driving vehicle to travel as a call taxi when there is a call from a guest. In addition, the service management controller 146 may temporarily terminate the traveling as the taxis and park the automated driving vehicle in a parking lot until the return time when the period in which the guest is not captured during traveling as the cruising taxi having no customer on board exceeds the predetermined period or more.

The second controller 160 controls the traveling driving force output device 200, the brake device 210, and the steering device 220 such that the automated driving vehicle passes the target trajectory generated by the action plan generating part 140 at the time of the schedule.

Returning to FIG. 9, the second controller 160 includes, for example, an acquisition part 162, a speed controller 164 and a steering controller 166. The acquisition part 162 acquires information of the target trajectory (the trajectory point) generated by the action plan generating part 140, and stores the information in a memory (not shown). The speed controller 164 controls the traveling driving force output device 200 or the brake device 210 on the basis of the velocity element accompanying with the target trajectory stored in the memory. The steering controller 166 controls the steering device 220 according to a curving condition of the target trajectory stored in the memory. Processing of the speed controller 164 and the steering controller 166 is realized by, for example, combination of feedforward control and feedback control. As an example, the steering controller 166 is executed by combination of feedforward control according to a curvature of a road in front of the automated driving vehicle and feedback control on the basis of the separation from the target trajectory.

The traveling driving force output device 200 outputs a traveling driving force (torque) that causes the vehicle to travel to a driving wheel. The traveling driving force output device 200 includes, for example, combinations of an internal combustion engine, an electric motor, a transmission, and the like, and an ECU configured to control them. The ECU controls the above-mentioned configuration according to information input from the second controller 160 or information input from the driving operator 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the second controller 160 or the information input from the driving operator 80 such that a braking torque is output to each wheel according to a braking operation. The brake device 210 may include a mechanism configured to transmit a hydraulic pressure generated according to an operation of a brake pedal included in the driving operator 80 to the cylinder via a master cylinder as a back-up. Further, the brake device 210 is not limited to the above-mentioned configuration and may be an electronically controlled hydraulic brake device configured to control an actuator according to the information input from the second controller 160 and transmit a hydraulic pressure of the master cylinder to the cylinder.

The steering device 220 includes, for example, a steering ECU and an electric motor. The electric motor changes an orientation of a steered wheel by, for example, applying a force to a rack and pinion mechanism. A steering ECU drives the electric motor and changes an orientation of the steered wheel according to the information input from the second controller 160 or the information input from the driving operator 80.

### [Sequence Diagram]

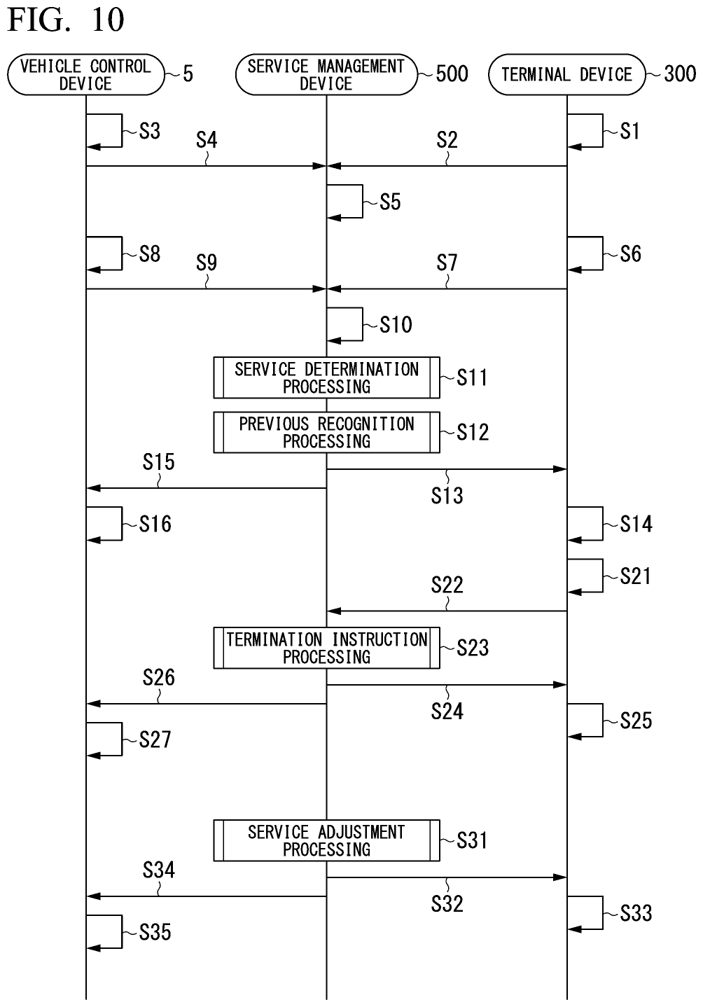

Hereinafter, a flow of a series of processing by the vehicle control system 1 of the embodiment will be described using a sequence diagram. FIG. 10 is a sequence diagram showing an example of a flow of a series of processing by the vehicle control system 1 according to the embodiment. For example, processing of the sequence diagram may be repeatedly performed at a predetermined cycle.

First, a usage schedule of the automated driving vehicle is input by the owner X using the terminal device 300 (step S1). The terminal device 300 transmits information indicating a usage schedule of the automated driving vehicle to the service management device 500 via a network NW on the basis of an operation by the owner X (step S2). In addition, the owner X may input a usage schedule of the automated driving vehicle using the HMI 30 of the vehicle control device 5 (step S3). The vehicle control device 5 transmits information indicating the usage schedule of the automated driving vehicle to the service management device 500 via the network NW on the basis of the operation by the owner X (step S4). The service management device 500 updates the schedule information 531 of the storage part 530 on the basis of the information received from the terminal device 300 or the vehicle control device 5 (step S5).

Next, the owner X inputs a service condition of the automated driving vehicle using the terminal device 300 (step S6). The terminal device 300 transmits the information indicating the service condition to the service management device 500 via the network NW on the basis of the operation by the owner X (step S7). In addition, the owner X may input the service condition of the automated driving vehicle using the HMI 30 of the vehicle control device 5 (step S8). The vehicle control device 5 transmits the information indicating the service condition to the service management device 500 via the network NW on the basis of the operation by the owner X (step S9). The service management device 500 updates the service conditions information 532 of the storage part 530 on the basis of the received information (step S10).

Then, the service management device 500 executes service determination processing (step S11). The service determination processing will be described below in detail. Next, when a predetermined time before a starting time of the second service determined by the service determination processing is reached, the service management device 500 performs previous confirmation processing (step S12). The previous confirmation processing is processing of, before the service to be provided is provided, determining whether the service to be provided can be provided, providing the service to be provided when the service to be provided can be provided, determining an alternative solution when the service to be provided cannot be provided, and starting to provide a service to be provided that is the alternative solution. The previous confirmation processing will be described below in detail. The service management device 500 transmits the processing results of the previous confirmation processing to the terminal device 300 (step S13). The terminal device 300 display the processing results of the previous confirmation processing on a display part thereof on the basis of the received information (step S14). In addition, the service management device 500 may transmit the processing results of the previous confirmation processing to the vehicle control device 5 (step S15). The vehicle control device 5 display the processing results of the previous confirmation processing on the HMI 30 on the basis of the received information (step S16).

During provision of the second service, the terminal device 300 transmit the changed contents to the service management device 500 (step S22) when an operation instructing change of the return time is received from the owner X (step S21). The service management device 500 performs termination instruction processing (step S23) on the basis of the changed contents received from the terminal device 300, and transmits the processing results to the terminal device 300 (step S24). The termination instruction processing will be described below in detail. The terminal device 300 display the received information on the display part thereof (step S25). In addition, the service management device 500 transmits the changed contents to the vehicle control device 5 when a first action plan (a destination, a traveling aspect, a traveling schedule, a traveling route, and the like) of the automated driving vehicle is changed in the termination instruction processing (step S26). The vehicle control device 5 control the automated driving vehicle according to the changed contents received from the service management device 500 (step S27).

Next, the service management device 500 performs the service adjustment processing (step S31), and transmits the processing results to the terminal device 300 (step S32) while the second service is provided. The service adjustment processing will be described below in detail. The terminal device 300 displays the received information on the display part thereof (step S33). In addition, the service management device 500 transmits the changed contents to the vehicle control device 5 when the first action plan of the automated driving vehicle is changed in the service adjustment processing (step S34). The vehicle control device 5 control the automated driving vehicle according to the changed contents received from the service management device 500 (step S35).

### [Processing Flow]

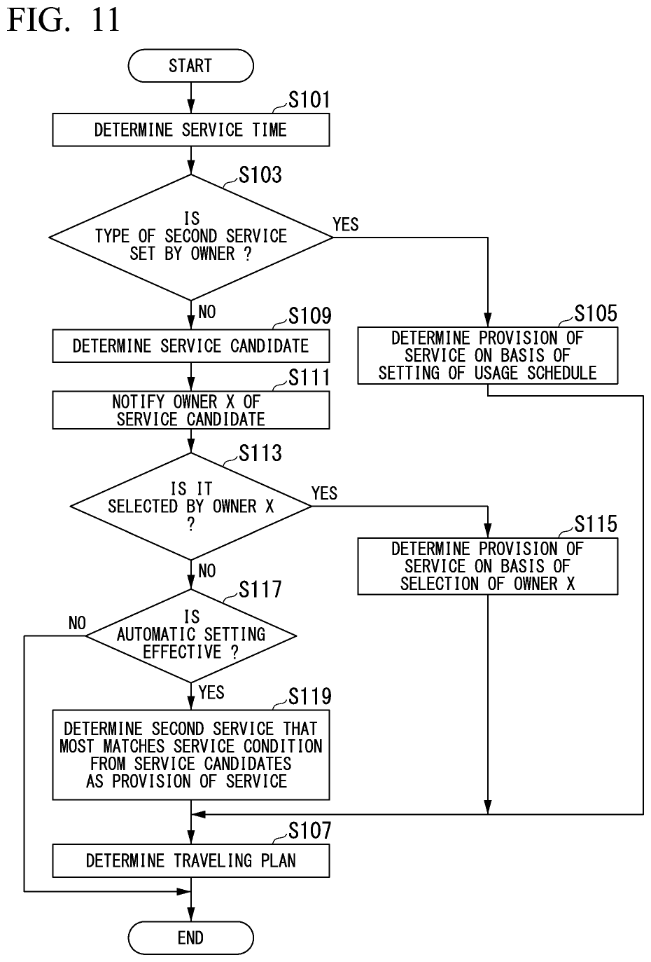

Hereinafter, a flow of each processing by the service management device 500 of the embodiment will be described using a flowchart. FIG. 11 is a flowchart showing an example of a flow of the service determination processing by the service management device 500. The processing of the flowchart is performed by each automated driving vehicle.

The service determination part 524 determines the service period when it is a predetermined timing (step S101). The predetermined timing is, for example, a timing when the schedule information 531 is updated, a timing which is a preset designated time (2 a.m. every day), or the like. When the service period is determined, the service determination part 524 determines whether a type of the second service has been set by the owner X in the determined service period (step S103). For example, when the type of the second service in the service period is designated in the usage schedule of the automated driving vehicle, the service determination part 524 determines the designated type of the second service as the service to be provided (step S105) and determines the first action plan according to the determined service to be provided (step S107). The service determination part 524 registers the determined service to be provided or the information related to the first action plan in the usage history information 535 of the storage part 530.

In step S103, when the type of the second service is not set in the service period, the service determination part 524 determines one or more service candidates in the service period (step S109). Then, the service determination part 524 transmits the information indicating the service candidate to the terminal device 300 or the vehicle control device 5, and notifies the owner X of the information (step S111). Next, the service determination part 524 determines whether any one of the service candidates is selected by the owner X (step S113). When the information indicating any one of the service candidates is received from the terminal device 300 or the vehicle control device 5, the service determination part 524 determines the service candidate selected by the owner X as the service to be provided (step S115), and determines the first action plan according to the determined service to be provided (step S107).

In step S113, when none of the service candidates has been selected by the owner X in the predetermined time after the service candidate is notified to the owner X, the service management device 500 determines whether automatic setting is effective (step S117). The fact that the automatic setting is effective indicates that the owner X agrees that the service determination part 524 determines an optimal second service as the service to be provided. When the automatic setting is effective, for example, the service determination part 524 determines the second service that most closely matches the service conditions from the service candidates as the service to be provided (step S119), and determines the first action plan according to the determined service to be provided (step S107).

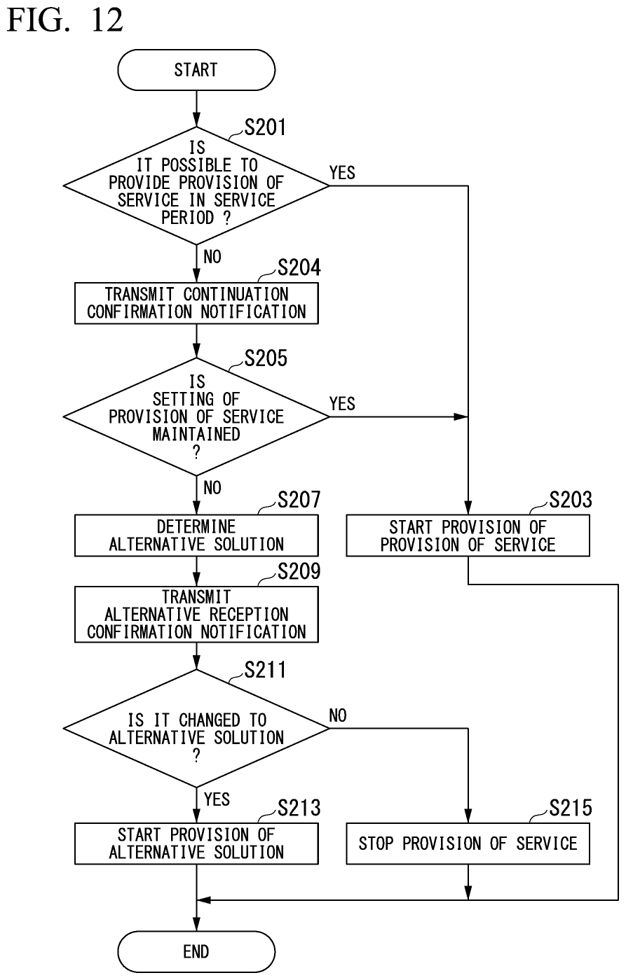

Next, FIG. 12 is a flowchart showing an example of a flow of the previous confirmation processing of the service management device 500. The processing of the flowchart is performed by each automated driving vehicle.

The service adjustment part 525 determines whether the service to be provided can be provided to fall into the service period when it becomes a predetermined time (for example, one hour) before a starting time of the service period (step S201). For example, the service adjustment part 525 determines whether the automated driving vehicle can return to the return point by the finish time of the service period when the automated driving vehicle travels on the basis of the first action plan determined by the service determination part 524. When it is possible to return by the finish time, the service adjustment part 525 determines that the service to be provided can be provided within the service period. When the service to be provided can be provided within the service period, the service management device 500 determines start of provision of the service to be provided (step S203). Further, the service adjustment part 525 determines whether the starting time of the service period of the service to be provided has been reached after determining the start of provision of the service to be provided, and starts provision of the service to be provided when it becomes the starting time.

In step S201, when the service to be provided cannot be provided to fall within the service period, the service adjustment part 525 transmits a continuation confirming notification for confirming whether the service to be provided will be continuously provided to the terminal device 300 or the vehicle control device 5 (step S204). For example, the service adjustment part 525 derives a predicted arrival time of the automated driving vehicle, and derives a delay time on the basis of the derived predicted arrival time and the finish time of the service period. The service adjustment part 525 transmits information indicating the derived predicted arrival time, the delay time, or the like, to the terminal device 300 or the vehicle control device 5. Accordingly, when the return time of the automated driven vehicle will be behind schedule, the owner X can determine whether the service to be provided should be cancelled before provision of the service or the service to be provided should still be provided without canceling. The service adjustment part 525 determines whether the settings of the service to be provided will be maintained on the basis of the information received from the terminal device 300 or the vehicle control device 5 (step S205).

In step S205, when the information indicating that the setting of the service to be provided is maintained is received from the terminal device 300 or the vehicle control device 5, the service adjustment part 525 moves to step S203. Further, when the fact that the continuation confirming notification is not required is set by the owner X, the service adjustment part 525 may move to step S415 without transmitting the continuation confirming notification.

In step S205, when the information indicating that the settings of the service to be provided will not be maintained is received from the terminal device 300 or the vehicle control device 5, the service determination part 524 determines an alternative solution (step S207). For example, the service determination part 524 determines a service that will fall within the service period from one or more service candidates determined in the service determination processing as an alternative solution. Further, the service determination part 524 may determine the service that most matches the service condition as the alternative solution when a plurality of services falls into the service period. Then, the service adjustment part 525 transmits the alternative reception confirmation notification to the terminal device 300 or the vehicle control device 5 (step S209). The alternative reception confirmation notification is notification for confirming whether a change from the service to be provided to the alternative solution will be approved.

The service adjustment part 525 determines whether the service is changed to the alternative solution on the basis of response with respect to the alternative reception confirmation notification received from the terminal device 300 or the vehicle control device 5 (step S211). When instruction of changing to the alternative solution from the terminal device 300 or the vehicle control device 5 is received, the service adjustment part 525 determines start of provision of the alternative solution (step S213). In step S211, when instruction of changing to the alternative solution is not received, provision of the second service in the service period is stopped (step S215).

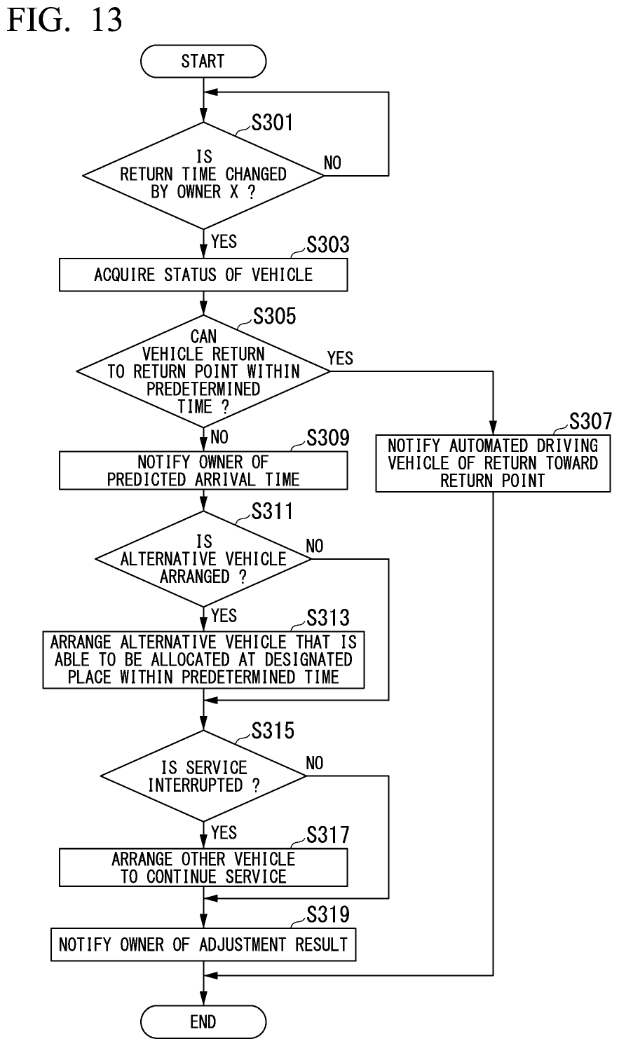

Next, FIG. 13 is a flowchart showing an example of a flow of termination instruction processing by the service management device 500. The processing of the flowchart is processing executed during provision of the service to be provided, which is performed by each automated driving vehicle. For example, the termination instruction processing is advantageous when the owner X wants to interrupt the service for some reason while a service is being provided.

The service adjustment part 525 judges whether termination of service provision has been instructed by the owner X (step S301). When a termination instruction for the service provision is received from the terminal device 300, the service adjustment part 525 refers to the location information 533 and the vehicle status information 534, and acquires the current status (for example, a progress status of the service, the current location, or the like) of the automated driving vehicle that is the target (step S303). Then, the service adjustment part 525 determines whether the automated driving vehicle can return to the return point within a predetermined time by immediately starting to travel toward the return point on the basis of the acquired current status of the automated driving vehicle (step S305). In step S305, when it is possible to return to the return point within the predetermined time, the service adjustment part 525 instructs the vehicle control device 5 to start traveling toward the return point (step S307). The service adjustment part 525 notifies the cleaning management server 700 or the allocation management server 900 of the instruction when the service being provided by processing in step S307 is interrupted. Accordingly, the automated driving vehicle can return to the return point within the predetermined time from the termination instruction of the service provision from the owner X.

In step S305, when the automated driving vehicle cannot return to the return point within the predetermined time, the service adjustment part 525 derives the predicted arrival time in a case the automated driving vehicle immediately starts to drive toward the return point, and transmits the predicted arrival time to the terminal device 300 (step S309).

In step S309, the service adjustment part 525 transmits also alternative vehicle arrangement confirmation notification for confirming whether an arrangement for an alternative vehicle is required to the terminal device 300. When the information instructing arrangement of the alternative vehicle is received from the terminal device 300 (step S311), the service adjustment part 525 arranges the alternative vehicle that can arrive at the return point within the predetermined time, and transmits the information related to the arranged alternative vehicle to the terminal device 300 (step S313). For example, the service adjustment part 525 may transmit an allocation request of the alternative vehicle to the allocation management server 900, and receive the information related to the alternative vehicle allocated by the allocation management server 900. Accordingly, the owner X can use the alternative vehicle even when his/her automated driving vehicle cannot return to the return point within the predetermined time.

In addition, in step S309, the service adjustment part 525 may transmit the continuation request confirmation notification for confirming whether the service being provided is interrupted and continuation of the service is requested to another vehicle to the terminal device 300. When information indicating that continuation of the service being provided with another vehicle has been requested is received from the terminal device 300 (step S315), the service adjustment part 525 arranges other vehicles that can be used for continuing the service being provided, and transmits the information related to the other arranged vehicles to the terminal device 300 (step S317). For example, the service adjustment part 525 transmits the allocation request of another vehicle that can continue the service being provided to the allocation management server 900, and receives the information related to the other vehicle allocated by the allocation management server 900. Accordingly, the owner X can return his/her automated driving vehicle to the return point as soon as possible.

Then, when an alternative vehicle or another vehicle is arranged in step S313 or step S317, the service adjustment part 525 transmits the results to the terminal device 300, and notifies the owner of the results (step S319).

Further, when the predicted arrival time derived in step S309 exceeds the current time by a predetermined time (when the waiting time is likely to be long) or when an alternative vehicle or another vehicle cannot be arranged, the service adjustment part 525 may determine that the service being provided cannot be terminated or interrupted, and transmit the determination result to the terminal device 300.

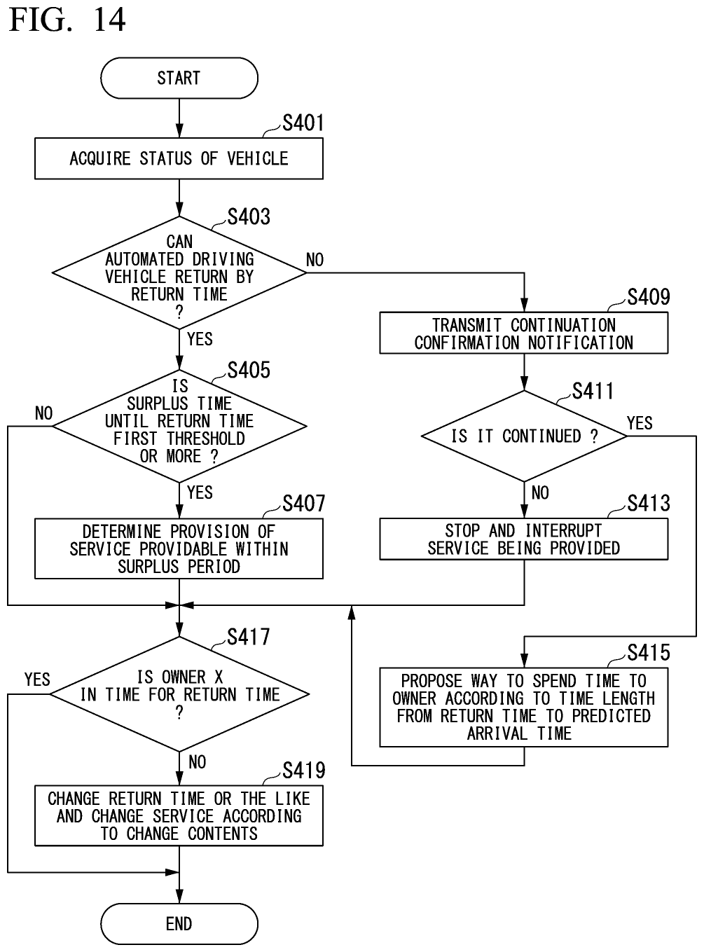

Next, FIG. 14 is a flowchart showing an example of a flow of service adjustment processing by the service management device 500. The processing of the flowchart is processing executed during provision of the service to be provided, which is performed by each automated driving vehicle.

The service adjustment part 525 refers to the location information 533 and the vehicle status information 534, and acquires the current status (for example, a progress status of the service, the current position, or the like) of the automated driving vehicle that is the target (step S401). The service adjustment part 525 determines whether the automated driving vehicle will be able to return to the return point by the return time on the basis of the acquired current status of the automated driving vehicle (step S403). For example, the service adjustment part 525 derives the predicted arrival time when the automated driving vehicle will arrive at the return point on the basis of the current status thereof, and determines that the automated driving vehicle will be able to return to the return point by the return time when the derived predicted arrival time is before the return time. In step S403, when it is determined that the automated driving vehicle returns to the return point by the return time, the service adjustment part 525 determines whether a period from the service usage finish time to the return time (hereinafter, referred to as a surplus period) is a first threshold or more (step S405).

When the surplus period is the first threshold or more, the service determination part 524 determines the service to be provided that can be provided in the surplus period (step S407). Further, as the determination technique of the service to be provided disclosed herein, the same technique as the determination technique of the achieved service to be provided can be used. Accordingly, the service to be provided can be provided in the surplus period.

In step S403, when the automated driving vehicle will not be able to return to the return point by the return time, the service adjustment part 525 transmits the continuation confirming notification for confirming whether the service being provided is continued to the terminal device 300 (step S409). When the information indicating that the service being provided is not continued is received from the terminal device 300 (step S411), the service adjustment part 525 performs each processing for terminating or interrupting the service being provided (step S413). For example, when traveling as a cruising taxi, the service adjustment part 525 terminates traveling as a taxi. In addition, when the automatic traveling vehicle travels as a taxi or a shared car with passengers, the service adjustment part 525 may arrange the other vehicle that can be connected to the service being provided, or transmit the information related to the other vehicle arranged to the terminal device 300.

In step S413, when the service being provided is interrupted, the service adjustment part 525 may transmit an interruption propriety confirmation notification for confirming whether interrupting the service being provided is acceptable or not to the vehicle control device 5. The vehicle control device 5 display the interruption propriety confirmation notification on the HMI 30. Accordingly, it is possible to confirm whether interrupting the service can be accepted by a sanitation worker who provides a cleaning service, a passenger in a taxi, or the like. The service adjustment part 525 may determine to interrupt the service being provided when the information indicating that interruption of the service being provided is agreed is received from the vehicle control device 5 and, may perform the processing for continuing the service being provided by judging that the service being provided cannot be interrupted when the information indicating that interruption of the service being provided is not agreed is received from the vehicle control device 5.

In step S411, when the information indicating that the service being provided is continued is received from the terminal device 300, the service adjustment part 525 determines how to spend time according to the time length from the return time to the predicted arrival time, and transmits the way to spend time to the terminal device 300 (step S415). For example, the service adjustment part 525 refers to the location information 533, acquires information related to a facility such as a cafe, a Karaoke box, or the like, adjacent to the current position of the owner X from an external server, and transmits the acquired information to the terminal device 300. Further, when the fact that the continuation confirming notification is not required is set by the owner X, the service adjustment part 525 may move to step S415 without transmitting the continuation confirming notification.

Next, the service adjustment part 525 determines whether the owner X returns to the return point by the return time (step S417). For example, the service adjustment part 525 acquires location information of the owner X with reference to the location information 533, derives a predicted time when the owner X arrives at the return point, and determines whether the derived predicted time exceeds the finish time of the service period. When the derived predicted time exceeds the finish time of the service period, the service adjustment part 525 changes setting (a return time or a return point) of the service being provided, and changes the details of the service according to the changed contents (step S419). For example, when a train which the owner X has boarded is delayed, when the owner X is late due to departure of the owner X is late, or the like, the service adjustment part 525 can extend the return time to extend a traveling time as a taxi or a charging time in the charging facility.

According to the embodiment described above, in the out-of-use period set in the usage schedule of the automated driving vehicle by the user, and in the out-of-use period in which the user does not use the automated driving vehicle, since the service management part 520 configured to provide the predetermined service provided in a state in which the user does not use the automated driving vehicle and service management controller 146 configured to cause the automated driving vehicle to automatically travel according to the predetermined service provided by the service management part 520 are provided, the automated driving vehicle can be widely used by users other than the owner.

### [Hardware Configuration]

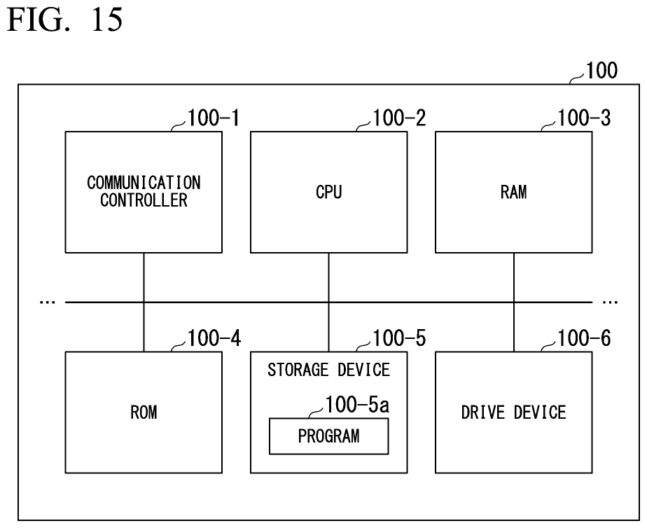

FIG. 15 is a view showing an example of a hardware configuration of the automated driving control device 100 of the embodiment. As shown, the automated driving control device 100 has a configuration in which a communication controller 100-1, a CPU 100-2, a RAM 100-3 used as a working memory, a ROM 100-4 in which a boot program or the like is stored, a storage device 100-5 such as a flash memory, an HDD, or the like, and a drive device 100-6 are connected to each other by an internal bus or a dedicated communication line. The communication controller 100-1 performs communication with components other than the automated driving control device 100. A program 100-5a executed by the CPU 100-2 is stored in the storage device 100-5. The program is expanded in the RAM 100-3 by a direct memory access (DMA) controller (not shown) or the like and executed by the CPU 100-2. Accordingly, a part or all of the first controller 120 and the second controller 160 are realized.

Hereinabove, while aspects of performing the present invention have been described using the embodiment, the present invention is not limited to the above-mentioned embodiment, and various modifications and substitutions may be made without departing from the scope of the present invention.

For example, at least one of the service management device 500 and the vehicle control device 5 may determine a return point of the automated driving vehicle on the basis of the location information 533. For example, when the owner X is moved from a shopping mall, the service determination part 524 may determine a position of the owner X after movement as a return point on the basis of the owner location information.

In addition, the service adjustment part 525 may periodically deliver the location information of the vehicle to the terminal device 300 of the owner X on the basis of the location information 533.

A part or all of the service management part 520 of the service management device 500 or a part or all of the information stored in the storage part 530 may be mounted on the vehicle control device 5, and a part or all of the service management controller 146 provided in the vehicle control device 5 may be provided in the service management device 500. That is, at least one of the service management part 520 and the service management controller 146 is included in “the controller” configured to cause the automated driving vehicle to automatically travel according to a predetermined service managed by the service management controller 146.

In addition, the usage schedule of the automated driving vehicle may be set by the owner X or the like using the HMI 30. Further, in “the reception part” that receives setting of the usage schedule of the automated driving vehicle by the user, the HMI 30 that directly receives setting by the owner X, the communication device 20 that receives setting by the owner X via the network NW and the service management device 500, the communication part 510 that receives setting by the owner X via the network NW and the terminal device 300, and the like, are included.

In addition, the second service is not limited to the above-mentioned service, and for example, may be a service of retrieving a cheaper parking lot and parking the vehicle, a service of returning to your home once and then picking you up, a service of sending adults to the company and then sending children to the cram school.

### REFERENCE SIGNS LIST

1 . . . vehicle control system, 5 . . . vehicle control device, 300 . . . terminal device, 500 . . . service management device, 700 . . . cleaning management server, 900 . . . allocation management server, 10 . . . camera, 12 . . . radar device, 14 . . . finder, 16 . . . object recognition device, 20 . . . communication device, 30 . . . HMI, 40 . . . vehicle sensor, 50 . . . navigation device, 60 . . . MPU, 70 . . . in-vehicle camera, 80 . . . driving operator, 100 . . . automated driving control device, 120 . . . first controller, 130 . . . recognition part, 140 . . . action plan generating part, 142 . . . event determination part, 144 . . . target trajectory generating part, 146 . . . service management controller, 160 . . . second controller, 162 . . . acquisition part, 164 . . . speed controller, 166 . . . steering controller, 200 . . . traveling driving force output device, 210 . . . brake device, 220 . . . steering device, 510 . . . communication part, 520 . . . service management part, 530 . . . storage part

1. A vehicle control system comprising:
a service management device configured to manage a predetermined service provided in a state in which a user is not using an automated driving vehicle during an out-of-use period which is set in a usage schedule of the automated driving vehicle of the user; and
a controller configured to generate an action plan of the automated driving vehicle in the out-of-use period according to the predetermined service managed by the service management device.

2. The vehicle control system according to claim 1, wherein the service management device notifies the user of one or more service candidates providable in the state in which the user is not using the automated driving vehicle, and performs processing such that a service selected by the user is provided as the predetermined service.

3. The vehicle control system according to claim 2, wherein the service management device notifies the user of an attribute of the service together with one or more service candidates providable in the state in which the user is not using the automated driving vehicle, the attribute of the service including at least one of (i) a content of each service included in the service candidates, (ii) a required time for each service included in the service candidates, and (iii) a permissibility for change which indicates easiness for changing each service included in the service candidates to a different service.

4. The vehicle control system according to claim 1, wherein, while the predetermined service is being provided, the service management device changes the content of the predetermined service which is currently being provided at least in one of a case in which (i) a setting of the predetermined service being provided has been changed and in which (ii) it is predicted that a setting of the predetermined service being provided will be changed.

5. The vehicle control system according to claim 1, wherein the service management device changes a setting related to the predetermined service being provided on the basis of information received from a terminal device of the user while the predetermined service being provided.

6. The vehicle control system according to claim 1, wherein the service management device transmits continuation confirming notification for confirming whether provision of the service should be continued to the terminal device of the user when it is predicted that the automated driving vehicle is unable to return to a designated place by a designated time while the predetermined service is being provided.

7. The vehicle control system according to claim 1, wherein the service management device determines the predetermined service on the basis of a joining time when the user joins with the automated driving vehicle after alighting of the user, the joining time being time information included in the usage schedule.

8. A vehicle control device comprising:
an acquisition part configured to acquire information related to a predetermined service provided in a state in which a user is not using the automated driving vehicle during an out-of-use period which is set in a usage schedule of the automated driving vehicle by the user; and
a controller configured to generate an action plan of the automated driving vehicle in the out-of-use period on the basis of the information acquired by the acquisition part.

9. A vehicle control method executed by one or more computers, the method comprising:
managing a predetermined service provided in a state in which a user is not using an automated driving vehicle during an out-of-use period which is set in a usage schedule of the automated driving vehicle by the user; and
generating an action plan of the automated driving vehicle in the out-of-use period according to the predetermined service.
